(19) United States
(12) Patent Application Publication
(10) Pub. No.: US 2024/0232647 A9
(43) Pub. Date: Jul. 11, 2024

(54) EFFICIENT SEARCH FOR DATA AUGMENTATION POLICIES

(71) Applicant: Waymo LLC, Mountain View, CA (US)

(72) Inventors: Zhaoqi Leng, Milpitas, CA (US); Guowang Li, Cupertino, CA (US); Chenxi Liu, Santa Clara, CA (US); Pei Sun, Palo Alto, CA (US); Tong He, Sunnyvale, CA (US); Dragomir Anguelov, San Francisco, CA (US); Mingxing Tan, Newark, CA (US)

(21) Appl. No.: 18/492,646

(22) Filed: Oct. 23, 2023

Related U.S. Application Data
(60) Provisional application No. 63/418,259, filed on Oct. 21, 2022.

(51) Int. Cl. G06N 3/0985

(52) U.S. Cl. CPC G06N 3/0985

(57) ABSTRACT

Methods, systems, and apparatus, including computer programs encoded on computer storage media, for training a machine learning model on training data. In one aspect, one of the methods include: obtaining a training data set comprising a plurality of training inputs; obtaining data defining an original search space of a plurality of candidate data augmentation policies; generating, from the original search space, a compact search space that has one or more global hyperparameters; and training the machine learning model on the training data using one or more final data augmentation policies generated from the compact search space.

### CROSS-REFERENCE TO RELATED APPLICATION

This application claims priority to U.S. Provisional Application Ser. No. 63/418,259, filed on Oct. 21, 2022. The disclosure of the prior application is considered part of and is incorporated by reference in the disclosure of this application.

### BACKGROUND

This specification relates to autonomous vehicles.

Autonomous vehicles include self-driving cars, boats, and aircraft. Autonomous vehicles use a variety of on-board sensors and computer systems to detect nearby objects and use such detections to make control and navigation decisions.

Some autonomous vehicles have computer systems that implement neural networks for object classification within data from sensors.

Neural networks, or for brevity, networks, are machine learning models that employ multiple layers of operations to predict one or more outputs from one or more inputs. In some cases, neural networks include one or more hidden layers situated between an input layer and an output layer. The output of each layer is used as input to another layer in the network, e.g., the next hidden layer or the output layer.

### BRIEF DESCRIPTION OF THE DRAWINGS

FIG. 1 is a block diagram of an example on-board system.

FIG. 2 is a block diagram of an example machine learning model training system.

FIG. 3 is an illustration of a table of a compact search space of data augmentation policies.

FIG. 4 is a flow diagram of an example process for training a machine learning model using one or more final data augmentation policies generated from a compact search space.

FIG. 5 is a flow diagram of sub-steps of one of the steps of the process of FIG. 4.

FIG. 6 is a flow diagram of sub-steps of another one of the steps of the process of FIG. 4.

Like reference numbers and designations in the various drawings indicate like elements.

### DETAILED DESCRIPTION

This specification describes a system implemented as computer programs on one or more computers in one or more locations that generates a compact search space of data augmentation policies from an original search space of data augmentation policies and then generates, from the compact search space, one or more data augmentation policies for augmenting a training data set.

The training data set is used for training a machine learning model to perform a particular machine learning task. The machine learning model can be configured through training to receive any kind of digital data input and to generate any kind of score, classification, or regression output based on the input.

In some cases, the training data set can be a set of image data, and the machine learning model can be an image perception machine learning model. For example, if the training inputs to the machine learning model are images or features that have been extracted from images, the output generated by the machine learning model for a given image may be scores for each of a set of object categories, with each score representing an estimated likelihood that the image contains an image of an object belonging to the category. As another example, if the training inputs to the machine learning model are images, the output generated by the machine learning model may be an object detection output that identifies regions in the image that are likely to depict an object that belongs to one of a set of one more categories of interest.

In some other cases, the training data set can be a set of point cloud data, and the machine learning model can be a point cloud perception machine learning model. For example, if the training inputs to the machine learning model are three-dimensional (3-D) point clouds generated by one or more LIDAR sensors, the output generated by the machine learning model may be scores for each of a set of object categories, with each score representing an estimated likelihood that the point cloud includes readings of an object belonging to the category.

As another example, if the training inputs to the machine learning model are point clouds generated by one or more sensors, the output generated by the machine learning model may be an object detection output that identifies, e.g., using 3-D bounding boxes, regions in the 3-D space sensed by the one or more sensors that are likely to include an object that belongs to one of a set of one more categories of interest.

As yet another example, the task can be a pose detection task for estimating the pose of objects in input 3-D point clouds. Generally, the pose of an object is a combination of the position and orientation of the object in the point cloud. For example, the machine learning model can generate as the model output a pose vector that includes an estimated location in the point cloud of each of a predetermined number of keypoints of the object, such as body joints of the human body.

In some other cases, the training data set can be a set of range image data, and the machine learning model can be a range image perception machine learning model, e.g., a range image classification or regression machine learning model. Range images are dense representations of the 3-D point clouds. Each range image includes a plurality of pixels. Each pixel in the range image corresponds to one or more points in the corresponding point cloud. Each range image pixel has at least a range value that indicates a distance of the corresponding one or more points for the pixel in the corresponding point cloud to the one or more sensors.

In some other cases, the training data set can be a set of high-dimensional data having a different modality such as video data or audio data, and the machine learning model can analogously be configured as a video (or audio) classification or regression machine learning model.

In yet other cases, the training data set is a combination of multiple individual training data sets, e.g., two or more of the training data sets mentioned above, such that the training data set can be used to train the machine learning model to perform multiple different individual machine learning tasks. For example, the machine learning model can be configured to perform multiple individual perception tasks, e.g., both a point cloud classification task and an image classification task, with different model inputs including different identifiers for the individual perception tasks to be performed on different model inputs.

During training, the system uses data augmentation techniques to improve data efficiency and model generalizability. More specifically, the system trains the machine learning model to determine trained values of the model parameters using an iterative training process and by using one or more data augmentation policies. Each data augmentation policy is selected from a search space of possible data augmentation policies. Each data augmentation policy is used to transform training inputs before the training inputs are used to train the machine learning models. The data augmentation policies can be used to increase the quantity, diversity, or both of the training inputs used in training the machine learning model, thereby resulting in the trained machine learning model performing the machine learning task more effectively (e.g., with greater prediction accuracy).

One of the challenges of adopting data augmentation in training machine learning models, e.g., models that process high-dimensional data, e.g., three-dimensional (3D) data, is that these data augmentation policies are often sensitive to input representations and model capacity. For example, range image-based models and point cloud-based models require different types of data augmentation policies due to different input representations. High capacity 3D perception machine learning models are typically prone to overfitting and require stronger overall data augmentation compared to light-weight models with fewer parameters.

Often, identifying specific data augmentation policies for different models is necessary. For example, data augmentation policies can be identified by applying a search technique, e.g., a progressive population based augmentation technique, a reinforcement learning technique, or a random technique, to the search of possible data augmentation policies. However, the search space of possible data augmentation policies scales exponentially with respect to the number of hyperparameters that define the search space; the search process thus consumes significant search cost, e.g., in terms of wall clock time or computational resources (e.g., memory and computing power.

To minimize the search cost, instead of directly identifying the data augmentation policy by searching through the original search space of possible data augmentation policies, the system therefore generates a compact search space of data augmentation policies from the original search space, and then generates, from the compact search space, one or more data augmentation policies for augmenting the training data set.

In other words, during the training of the machine learning model, the data augmentation policies that will be used to transform the training inputs are not identified directly from the original search space, but are rather identified from the compact search space, which is in turn generated by the system from the original search space by using the search space compaction techniques as will be described below.

More specifically, the system can transform a large search space of candidate data augmentation policies into a compact search space that is smaller, and sometimes much smaller, than the large search space through grid search to determine the constants, coefficients, or both that can will be used to define each local hyperparameter of a respective candidate data augmentation policy in the large search space in terms of one or more global hyperparameters that are shared across the compact search space, and then determine an optimal data augmentation policy for training a machine learning model by searching the compact search space, i.e., instead of the large search space, to determine the optimal values of the global hyperparameters.

While the large search space can be a predefined search space with any size or any level of complexity, the number of global hyperparameters will remain fixed and thus keeping the size of compact search space to a reasonable order of magnitude. In particular, the size of the compact search space does not scale proportionally to the number of candidate data augmentation policies in the large search space. Nor does the size of the compact search space scale proportionally to the total number of local hyperparameters of each policy in the large search space.

Searching through the compact search space can be significantly quicker and less computationally expensive than existing approaches that rely on some complex search algorithms to explore prohibitively large search spaces. The data augmentation system can thus make more efficient use of computational resources, e.g., processor cycles, wall clock time, or both, when determining the optimal data augmentation policy for training the machine learning model while preserving the diversity of the candidate data augmentation policies in the large search space, and hence ensuring the quality of the training.

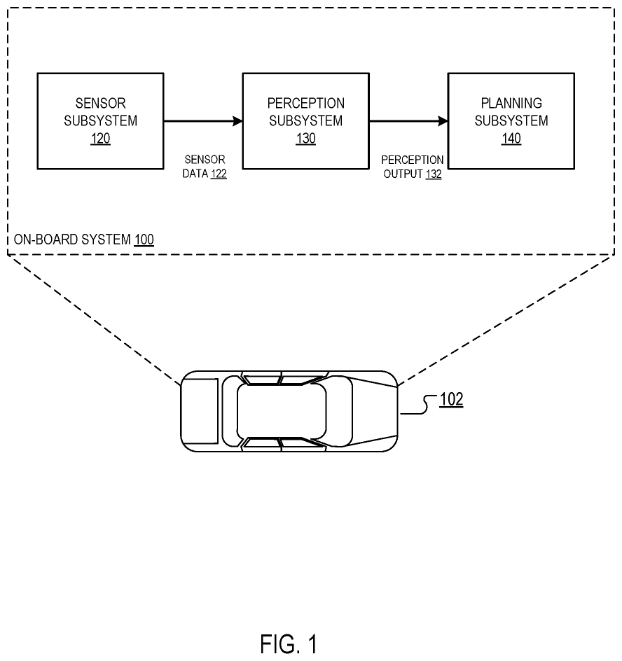

FIG. 1 is a block diagram of an example on-board system 100. The on-board system 100 is physically located on-board a vehicle 102. The vehicle 102 in FIG. 1 is illustrated as an automobile, but the on-board system 100 can be located on-board any appropriate vehicle type. The vehicle 102 can be a fully autonomous vehicle that makes fully-autonomous driving decisions or a semi-autonomous vehicle that aids a human operator. For example, the vehicle 102 can autonomously apply the brakes if a full-vehicle prediction indicates that a human driver is about to collide with a detected object, e.g., a pedestrian, a cyclist, another vehicle.

While the vehicle 102 is illustrated in FIG. 1 as being an automobile, the vehicle 102 can be any appropriate vehicle that uses sensor data to make fully-autonomous or semi-autonomous operation decisions. For example, the vehicle 102 can be a watercraft or an aircraft. Moreover, the on-board system 100 can include components additional to those depicted in FIG. 1 (e.g., a control subsystem or a user interface subsystem).

The on-board system 100 includes a sensor subsystem 120 which enables the on-board system 100 to “see” the environment in a vicinity of the vehicle 102. The sensor subsystem 120 includes one or more sensors, some of which are configured to receive reflections of electromagnetic radiation from the environment in the vicinity of the vehicle 102. For example, the sensor subsystem 120 can include one or more laser sensors (e.g., LIDAR sensors) that are configured to detect reflections of laser light. As another example, the sensor subsystem 120 can include one or more radar sensors that are configured to detect reflections of radio waves. As another example, the sensor subsystem 120 can include one or more camera sensors that are configured to detect reflections of visible light.

The sensor subsystem 120 repeatedly (i.e., at each of multiple time points) uses raw sensor measurements, data derived from raw sensor measurements, or both to generate sensor data 122. The raw sensor measurements indicate the directions, intensities, and distances travelled by reflected radiation. For example, a sensor in the sensor subsystem 120 can transmit one or more pulses of electromagnetic radiation in a particular direction and can measure the intensity of any reflections as well as the time that the reflection was received. A distance can be computed by determining the time which elapses between transmitting a pulse and receiving its reflection. Each sensor can continually sweep a particular space in angle, azimuth, or both. Sweeping in azimuth, for example, can allow a sensor to detect multiple objects along the same line of sight.

For example, the sensor data 122 can include image data that characterizes a latest state of the environment (i.e., an environment at the current time point) in the vicinity of the vehicle 102. Each image includes a plurality of pixels. The image data can be captured by any camera sensor (e.g., a still camera, a video camera, etc.) that are on-board the vehicle 102.

As another example, the sensor data 122 can include point cloud data that characterizes the latest state of the environment in the vicinity of the vehicle 102. A point cloud is a collection of data points defined by a given coordinate system.

For example, in a three-dimensional (3-D) coordinate system, a point cloud can define the shape of some real or synthetic physical system, where each point in the point cloud is defined by three values representing respective coordinates in the coordinate system, e.g., (x, y, z) coordinates.

As another example, in a three-dimensional coordinate system, each point in the point cloud can be defined by more than three values, where three values represent coordinates in the coordinate system and the additional values each represent a property of the point of the point cloud, e.g., an intensity of the point in the point cloud.

In this specification, for convenience, a “point cloud” will refer to a three-dimensional point cloud, i.e. each point is defined by three values, but in general a point cloud can have a different dimensionality, e.g. two-dimensional or four-dimensional. Point cloud data can be generated, for example, by using LIDAR sensors or depth camera sensors that are on-board the vehicle 102.

As another example, the sensor data 122 can include range image data that characterizes the latest state of the environment in the vicinity of the vehicle 102. Range images are dense representations of the 3-D point clouds. Each range image includes a plurality of pixels. Each pixel in the range image corresponds to one or more points in the corresponding point cloud. Each range image pixel has at least a range value that indicates a distance of the corresponding one or more points for the pixel in the corresponding point cloud to the one or more sensors.

The on-board system 100 can provide the sensor data 122 generated by the sensor subsystem 120 to a perception subsystem 130 for use in generating perception outputs 132.

The perception subsystem 130 implements components that identify objects within a vicinity of the vehicle. The components typically include one or more fully-learned machine learning models. A machine learning model is said to be “fully-learned” if the model has been trained to compute a desired prediction when performing a perception task. In other words, a fully-learned model generates a perception output based solely on being trained on training data rather than on human-programmed decisions.

For example, the perception output 132 may be a classification output that includes a respective object score corresponding to each of one or more object categories, each object score representing a likelihood that the sensor data 122 characterizes an object belonging to the corresponding object category.

As another example, the perception output 132 can include data defining one or more bounding boxes, e.g., 2-D or 3-D bounding boxes, in the sensor data 122, and optionally, for each of the one or more bounding boxes, a respective confidence score that represents a likelihood that an object belonging to an object category from a set of one or more object categories is present in the region of the environment shown in the bounding box. Examples of object categories include pedestrians, cyclists, or other vehicles near the vicinity of the vehicle 102 as it travels on a road.

As yet another example, the perception output 132 can include data defining the estimated poses of objects in sensor data 122. Generally, the pose of an object is a combination of the position and orientation of the object in the point cloud. For example, the perception output 132 can be a pose vector that includes an estimated location in the sensor data 122 of each of a predetermined number of keypoints of the object, such as body joints of the human body.

The on-board system 100 can provide the perception output 132 to a planning subsystem 140. When the planning subsystem 140 receives the perception outputs 132, the planning subsystem 140 can use the perception outputs 132 to generate planning decisions which plan the future trajectory of the vehicle 102.

The planning decisions generated by the planning subsystem 140 can include, for example: yielding (e.g., to pedestrians), stopping (e.g., at a “Stop” sign), passing other vehicles, adjusting vehicle lane position to accommodate a bicyclist, slowing down in a school or construction zone, merging (e.g., onto a highway), and parking. The planning decisions generated by the planning subsystem 140 can be provided to a control system (not shown in the figure) of the vehicle 102. The control system of the vehicle can control some or all of the operations of the vehicle by implementing the planning decisions generated by the planning system. For example, in response to receiving a planning decision to apply the brakes of the vehicle, the control system of the vehicle 102 may transmit an electronic signal to a braking control unit of the vehicle. In response to receiving the electronic signal, the braking control unit can mechanically apply the brakes of the vehicle.

In order for the planning subsystem 140 to generate planning decisions which cause the vehicle 102 to travel along a safe and comfortable trajectory, the on-board system 100 must provide the planning subsystem 140 with high quality perception outputs 132. In various scenarios, however, accurately classifying or detecting objects within sensor data, e.g., point cloud data, range image data, or image data, can be challenging. This is sometimes due to insufficient diversity or inferior quality of point cloud (or range image or image) training data, i.e., the data that is used in training the machine learning models to perform point cloud (or range image or image) perception tasks.

In this specification, data diversity refers to the total amount of different characteristics that are possessed by the training data which can include, for example, weather, season, region, or illumination characteristics. For example, a machine learning model that has been specifically trained on training data that is derived from primarily daytime driving logs may fail to generate high quality perception outputs when processing nighttime sensor data. As another example, a machine learning model that has been specifically trained on training data that is primarily collected under normal weather conditions may experience degraded performance on perception tasks under adverse or inclement weather conditions such as rain, fog, hail, snow, dust, and the like.

Thus, to generate perception outputs with greater overall prediction accuracy, the perception subsystem 130 implements one or more machine learning models that have been trained using respective data augmentation policies. The data augmentation policy can be used to increase the quantity and diversity of the training inputs used in training the machine learning model, thereby resulting in the trained machine learning model performing the perception tasks more effectively.

That is, once trained, the machine learning model can be deployed within the perception subsystem 130 to accurately detect or classify objects within sensor data generated by the sensor subsystem 120 without using the data augmentation policy. Generating a trained machine learning model using one or more data augmentation policies will be described in more detail below.

It should be noted that, while the description in this specification largely relates to training a machine learning model to perform a perception task by processing sensor data, the described techniques can also be used for training the model that is configured to perform other appropriate machine learning tasks, including, for example, localization, mapping, and planning tasks.

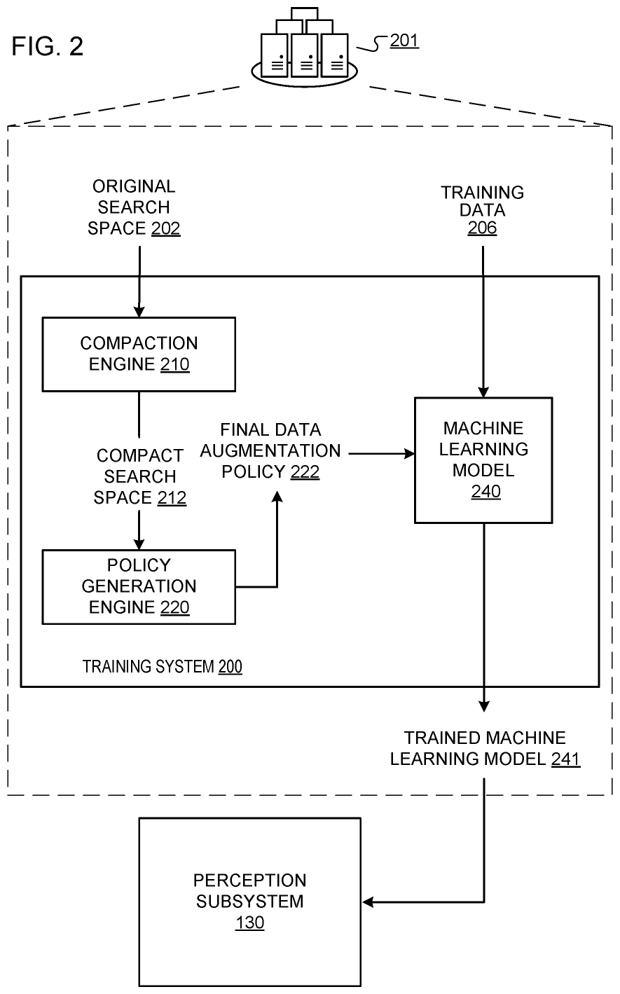

FIG. 2 shows an example of a machine learning model training system 200. The training system 200 is an example of a system implemented as computer programs on one or more computers in one or more locations in which the systems, components, and techniques described below are implemented.

To allow the perception subsystem 120 to accurately perform perception tasks by processing sensor data, e.g., accurately detecting or classifying objects within the sensor data, the training system 200 can generate a trained machine learning model 241 to be included in the perception subsystem 130 and that has been trained using one or more data augmentation policies. While the perception subsystem 130 may be implemented on-board a vehicle as described above, the training system 200 is typically hosted within a data center 201, which can be a distributed computing system having hundreds or thousands of computers in one or more locations.

The training system 200 is configured to generate the trained machine learning model 241 by training a machine learning model 240 using: (i) the training data 206, and (ii) one or more “final” data augmentation policies 222. As will be described in more detail below, the training system 200 uses a compaction engine 210 to generate a compact search space 212 from an original search space 202 of candidate data augmentation policies, and subsequently uses a policy generation engine 220 to identify, as the final data augmentation policies 222, one or more data augmentation policies from the compact search space 212.

The training data 206 is composed of multiple training examples, where each training example specifies a training input and a corresponding target output. The training input includes sensor data, e.g., a point cloud, a range image, an image, or the like. The target output represents the output that should be generated by the machine learning model by processing the training input. For example, the target output may be a classification output that specifies a category (e.g., object class) corresponding to the sensor data, or a regression output that specifies one or more continuous variables corresponding to the sensor data (e.g., object bounding box coordinates).

The machine learning model 240 can have any appropriate machine learning model architecture. For example, the machine learning model 240 may be a neural network model, a random forest model, a support vector machine (SVM) model, a linear model, or a combination thereof.

As a particular example, the machine learning model 240 is a neural network that includes one or more multi-layer perceptions (MLPs) that processes the model input, followed by a fully convolutional backbone (e.g., that has a Res U-net architecture) that processes the output of the MLPs, followed by one or more prediction heads that processes the output of the fully convolutional backbone to generate the output of the machine learning model 240. For example, the one or more prediction heads can include a heatmap prediction head, a bounding box regression head, and so on.

The training system 200 can receive the training data 206, data defining the original search space 202, and data defining (the architecture of) the machine learning model 240 in any of a variety of ways. For example, the training system 220 can receive training data 206, the data defining the original search space 202, or the data defining the machine learning model 240 as an upload from a remote user of the training system 200 over a data communication network, e.g., using an application programming interface (API) made available by the system 200. As another example, the training system 200 can receive an input from a user specifying which data that is already maintained by the training system 200 (e.g., in one or more physical data storage devices), or another system that is accessible by the training system 200, should be used as the training data 206, the data defining the original search space 202, or the data defining the machine learning model 240.

The original search space 202 can refer to a set of an arbitrary number of possible data augmentation policies, where each possible data augmentation policy defines a corresponding procedure for processing a training input to generate a transformed training input. In this specification, the set of possible data augmentation policies is referred to as the “original search space,” and each of the possible data augmentation policies within the original search space is referred to as a “candidate data augmentation policy.”

The original search space 202 can be parameterized as a set of hyperparameters (referred to in this specification as “local hyperparameters”). For example, each candidate data augmentation policy included in the original search space 202 can have one or more respective local hyperparameters that correspond to different aspects of the procedure defined by the candidate data augmentation policy.

Each local hyperparameter has a space of possible values. The space of possible values can be either discrete or continuous. A space of possible values for a local hyperparameter is discrete when the set of possible values for the local hyperparameter is discrete, i.e., includes a fixed finite set of values, e.g., {0.3, 0.5, 0.7, 0.9},

$$\{ 0 , \frac{π}{2} , π , \frac{3 π}{2} \} ,$$

or the like. In contrast, a space of possible values for a local hyperparameter is continuous when the value for the local hyperparameter is selected from a continuous range of possible values, e.g., [0, 1], [0, ∞], or the like.

In some implementations, the original search space 202 can include a plurality of transformation operations. For example, when the training inputs include point cloud data, the transformation operations may be any appropriate sort of point cloud processing operations including, for example, dropping out data points, replicating data points, changing background data points, rotating data points, scaling data points, adding noisy data points, translating data points, flipping data points, or a combination thereof. Specifically, some or all of the transformation operations in this example can be transformation operations that account for occlusions from a point of view of the LIDAR sensor that generates the sensor data, e.g., by removing overlapping rays in range view based on distance.

As another example, when the training inputs include range image data, the transformation operations may be any appropriate sort of range image processing operations including, for example, object pastings operations, background swap operations, or a combination thereof.

As yet another example, when the training inputs include image data, the transformation operations may be any appropriate sort of image processing operations including, for example, translation operations, rotation operations, shearing operations, color inversion operations, or a combination thereof.

In these implementations, each candidate data augmentation policy in the original search space 202 can be composed of a sequence of one or more transformation operations. The transformation operations can be used to transform training inputs included in the training data 206 before the training inputs are used to train the machine learning model 240, i.e., are processed by the model during the training. By including one or more transformation operations that can be applied sequentially one after another on a training input, each candidate data augmentation policy thus defines a procedure for processing the training input to generate a transformed training input.

Moreover, in these implementations, each aspect of the procedure defined by the candidate data augmentation policy can correspond to a different transformation operation included in the candidate data augmentation policy; thus different transformation operations can have different local hyperparameters. The one or more local hyperparameters of each transformation operation generally specify how the transformation operation should be applied to a training input, e.g., the magnitude of the transformation operation, or the probability of applying the transformation operation.

After receiving the data that defines the original search space 202 of the plurality of candidate data augmentation policies, the training system 200 uses a compaction engine 210 to generate a compact search space 212 from the original search space 202.

Like the original search space 202, the compact search space 212 refers to a set of an arbitrary number of candidate data augmentation policies, where each candidate data augmentation policy defines a corresponding procedure for processing a training input to generate a transformed training input. In fact, the set of candidate data augmentation policies included in the compact search space 212 can be much the same as the set of candidate data augmentation policies included in the original search space 202.

Unlike the original search space 202, however, the compact search space 212 is parameterized as a different, smaller set of hyperparameters (referred to in this specification as “global hyperparameters”) and, in particular, the number of global hyperparameters of the compact search space 212 is significantly lower than the number of local hyperparameters of the original search space 202. Each global hyperparameter has a space of possible values, which can either be a discrete space or a continuous space.

In some implementations, the compact search space 212 can include the same plurality of transformation operations as the original search space 202. Thus, each candidate data augmentation policy in the compact search space 212 can be composed of a sequence of one or more transformation operations. The transformation operations can be used to transform training inputs included in the training data 206 before the training inputs are used to train the machine learning model 240, i.e., are processed by the model during the training.

In these implementations, rather than having one or more local hyperparameters for each transformation operation and hence having a large number of local hyperparameters for all of the transformation operations included in the original search space 202, the compact search space 212 has a limited number global hyperparameters that correspond to all of these transformation operations included in the compact search space 212. The limited number of global hyperparameters in the compact search space 212 is generally much smaller, for example orders of magnitude smaller, than the total number of local hyperparameters in the original search space 202.

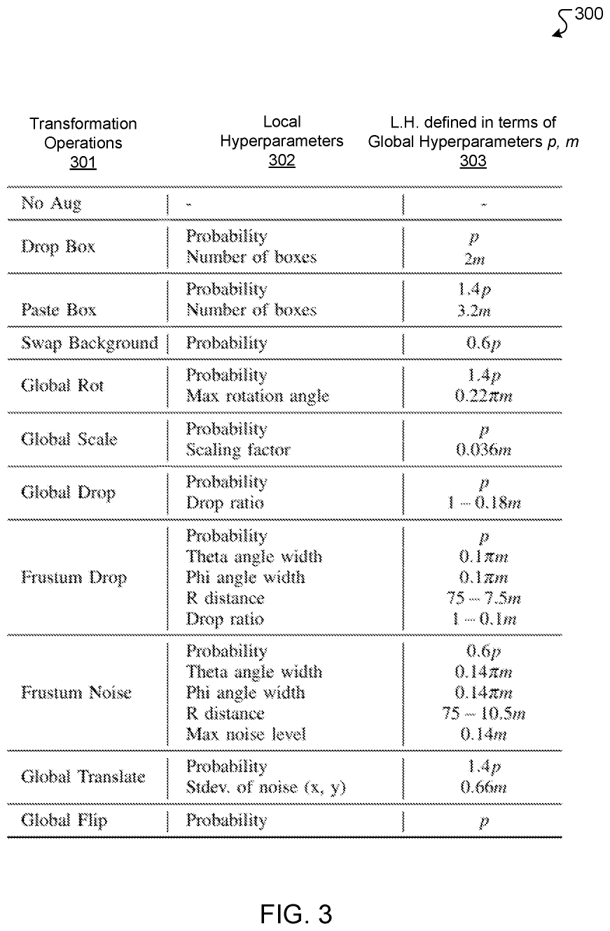

FIG. 3 is an illustration of a table 300 of a compact search space of data augmentation policies. The table 300 of FIG. 3 has three columns. Column 301 lists a plurality of transformation operations included in an original search space that can be used to transform a training input that includes point cloud data. The plurality of transformation operations are the same for both the original search space and the compact search space.

Column 302 lists the one or more local hyperparameters associated with each transformation operation included in the original search space. As illustrated, different transformation operations generally have different local hyperparameters that specify how the transformation operations should be applied to a training input, e.g., the magnitude of a transformation operation, or the probability of applying a transformation operation.

Details about the transformation operations and their associated local hyperparameters listed in columns 301 and 302 can be found in S. Cheng, Z. Leng, E. D. Cubuk, B. Zoph, C. Bai, J. Ngiam, Y. Song, B. Caine, V. Vasudevan, C. Li et al., “Improving 3d object detection through progressive population based augmentation,” in European Conference on Computer Vision. Springer, 2020, pp. 279-294, and in Z. Leng, S. Cheng, B. Caine, W. Wang, X. Zhang, S. Jonathon, M. Tan, and A. Dragomir, “Pseudoaugment: Learning to use unlabeled data for data augmentation in point clouds,” in European Conference on Computer Vision. Springer, 2022, pp. 279-294.

In the example of FIG. 3, while the original search space includes a total of 24 local hyperparameters for the various transformation operations included therein, the compact search space includes as few as two global hyperparameters, including a global magnitude hyperparameter m and a global probability hyperparameter p.

The compaction engine 210 generates the compact search space 212 from the original search space 202 by generating a definition of each local hyperparameter in terms of one or more of the global hyperparameters, thereby mapping the local hyperparameter to the global hyperparameters.

More specifically, the compaction engine 210 defines each of the one or more respective local hyperparameters of the original search space 202 in terms of one or more of the global hyperparameters by using (i) one or more normalization coefficients, (ii) one or more normalization constants, or both (i) and (ii). In table 300 of FIG. 3, column 303 lists how each local hyperparameter can be defined in terms of one or both of the two global hyperparameters.

For each local hyperparameter, the compaction engine 210 determines a value of a normalization coefficient. Additionally or alternatively, the compaction engine 210 determines a value of a normalization constant. In mathematical expressions, a coefficient is a number that is being multiplied by a variable, whereas a constant is a number that has a fixed value. For example, in the mathematical expression of 1−0.18 m, 1 is the constant that is not in front of any other variable, and −0.18 is the coefficient that is being multiplied by a variable (the global magnitude hyperparameter m).

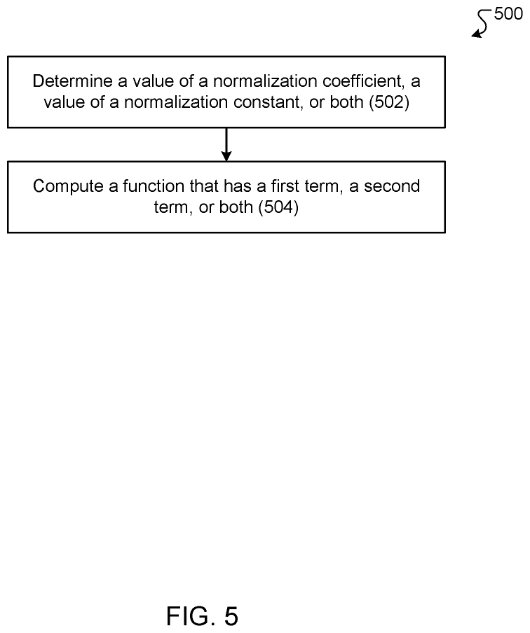

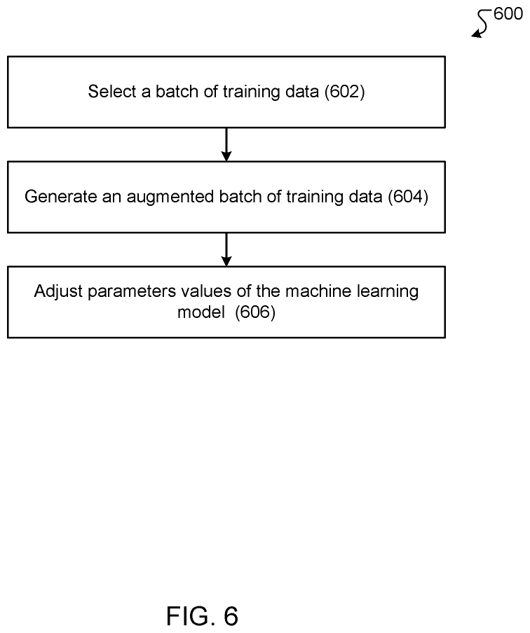

Determining the value of the normalization coefficient, the value of the normalization constant, or both for each local hyperparameter will be described further below with reference to FIGS. 5-6, but in general, the compaction engine 210 can determine different values for different candidate transformation operations, such that the value of the normalization coefficient, the value of the normalization constant, or both of one data augmentation policy are different from the value of the normalization coefficient, the value of the normalization constant, or both of another data augmentation policy.

To define each local hyperparameter in terms of the one or more of the global hyperparameters, the compaction engine 210 computes a function that has (i) a first term representing a product between a global hyperparameter and the normalization coefficient having the determined value, (ii) a second term representing the normalization constant having the determined value, or both (i) the first term and (ii) the second term.

For example, as illustrated in FIG. 3, the “Global Drop” transformation operation (dropping out data points within a point cloud) has two local hyperparameters: probability (a probability of applying the transformation operation to a training input), and drop ratio (a ratio of dropped out points to all points in the training input). Defining each of these two local hyperparameters in terms of one or both of the global magnitude hyperparameter m and a global probability hyperparameter p are explained below:
(1) The probability hyperparameter is defined as a product between the global probability hyperparameter p and a normalization coefficient. The normalization coefficient has the determined value of 1.
(2) The drop ratio hyperparameter is defined as a function that has a first term and a second term. The first term represents a product between the global magnitude hyperparameter m and the normalization coefficient, which has the determined value of −0.18. The second term represents the normalization constant, which has the determined value of 1.

As another example, the “Frustum Drop” transformation operation (dropping out data points within a frustum in a point cloud) has five local hyperparameters: probability, theta angle width, phi angle width, R distance, and drop ratio. Defining each of these five local hyperparameters in terms of one or both of the global magnitude hyperparameter m and a global probability hyperparameter p are explained below:
(1) The probability hyperparameter is defined as a product between the global probability hyperparameter p and a normalization coefficient. The normalization coefficient has the determined value of 1.
(2) The theta angle width hyperparameter is defined as a product between the global magnitude hyperparameter m and a normalization coefficient. The normalization coefficient has the determined value of 0.1π.
(3) The phi angle width hyperparameter is defined as a product between the global magnitude hyperparameter m and a normalization coefficient. The normalization coefficient has the determined value of 0.1π.
(4) The R distance hyperparameter is defined as a function that has a first term and a second term. The first term represents a product between the global magnitude hyperparameter m and the normalization coefficient, which has the determined value of −7.5. The second term represents the normalization constant, which has the determined value of 75.
(5) The drop ratio hyperparameter is defined as a function that has a first term and a second term. The first term represents a product between the global magnitude hyperparameter m and the normalization coefficient, which has the determined value of −0.1. The second term represents the normalization constant, which has the determined value of 1.

The training system 200 can then use a policy generation engine 220 to identify one or more final data augmentation policies 222 from the compact search space 212, and then generate the trained machine learning model 241 by training an instance of the machine learning model 240 to perform a particular machine learning task on the training data 206 using the final data augmentation policies 222. The final data augmentation policies 222 are used to transform training inputs included in the training data 206 before the training inputs are used to train the machine learning model 240, i.e., are processed by the model during the training.

Once trained, the training system 200 can provide, e.g., by a wired or wireless connection, data specifying the trained machine learning model 241, e.g., the trained values of the parameters of the machine learning model and, in some cases, data specifying the architecture of the machine learning model, to the on-board system 100 of vehicle 102 for use in performing perception tasks by processing sensor data, e.g., detecting or classifying objects within the sensor data. In cases where the final data augmentation policies 222 may be transferable to other data (e.g., another set of training data), the training system 200 can also output data specifying the final data augmentation policies 222 in a similar manner, e.g., to another system.

As will be described further below, in some implementations, the policy generation engine 220 can generate the one or more final data augmentation policies 222 by performing a search phase within the compact search space 212 before training the machine learning model 240. During the search phase, the policy generation engine 220 can search the compact search space 212 to find optimal values of the global hyperparameters that define the one or more final data augmentation policies.

In some other implementations, the policy generation engine 220 can generate the one or more final data augmentation policies 222 for training the machine learning model 240 without executing a search phase before the training. Rather, the policy generation engine 220 can determine optimal values of the global hyperparameters in parallel with determining other hyperparameters, parameters, or both of the machine learning model 240 itself.

In any of these implementations, having such a compact search space 212, which can be parameterized by as few as two global hyperparameters, will allow the policy generation engine 220 to generate the one or more final data augmentation policies 222 by determining the optimal values of the global hyperparameters with reduced latency and while consuming fewer computational resources than what would otherwise be required to search though the possible values for all of the local hyperparameters in the original search space 202.

It has been contemplated that the techniques used by the training system 200 to transform an original, large search space into a compact search space are universally applicable to any type of data augmentation policy for any type of technical task that machine learning models may be applied to. For example, the training system 200 can train a perception neural network for processing point cloud data, for example to recognize objects or persons in the data. Deploying the perception neural network within an on-board system of a vehicle can be further advantageous, because the perception neural network in turn enables the on-board system to generate better-informed planning decisions which in turn result in a safer journey.

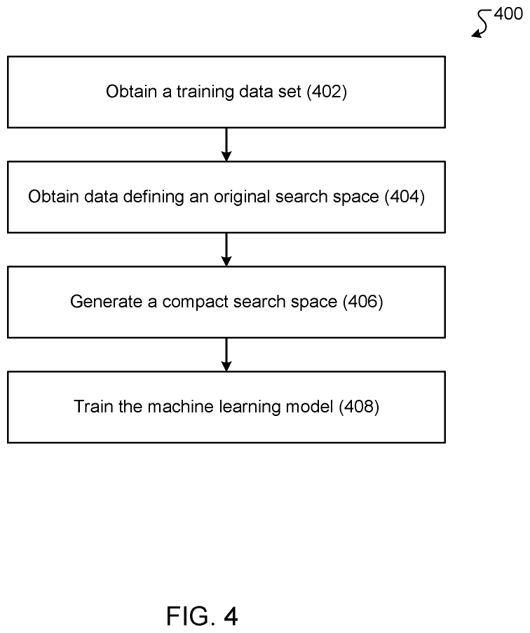

FIG. 4 is a flow diagram of an example process 400 for training a machine learning model using one or more final data augmentation policies generated from a compact search space. For convenience, the process 400 will be described as being performed by a system of one or more computers located in one or more locations. For example, a system, e.g., the training system 200 of FIG. 2, appropriately programmed in accordance with this specification, can perform the process 400.

The system obtains a training data set for training a machine learning model to perform a particular machine learning task (step 402). The machine learning model includes a plurality of model parameters. The training data set includes a plurality of training inputs. Each training input can include sensor data, e.g., a point cloud, a range image, an image, or the like. Each training input can be associated with a corresponding target output, which represents the output that should be generated by the machine learning model by processing the training input.

The system obtains data defining an original search space of a plurality of candidate data augmentation policies (step 404). Each candidate data augmentation policy defines a procedure for processing (e.g., modifying) a training input to generate a transformed training input. Each candidate data augmentation policy has one or more respective local hyperparameters corresponding to different aspects of the procedure defined by the candidate data augmentation policy. Each local hyperparameter has a space of possible values. The space of possible values can be either discrete or continuous.

In some implementations, each candidate data augmentation policy in the original search space is composed of a sequence of one or more transformation operations, with each transformation operation corresponding to a different aspect of the procedure defined by the candidate data augmentation policy. The one or more local hyperparameters of each transformation operation generally specify how the transformation operation should be applied to a training input, e.g., the magnitude of the transformation operation, or the probability of applying the transformation operation.

For example, when the training inputs include image data, the transformation operations may be any appropriate sort of image processing operations including, for example, translation operations, rotation operations, shearing operations, color inversion operations, or a combination thereof. Each of one or more of these transformation operations has a first local hyperparameter defining a magnitude and a second local hyperparameter defining a probability. The magnitude of a transformation operation specifies how the transformation operation should be applied to a training input. For example, the magnitude of a translation operation may specify the number of pixels an image should be translated in the x- and y-directions. As another example, the magnitude of a rotation operation may specify the number of radians by which an image should be rotated.

As another example, when the training inputs include point cloud data, the transformation operations may be any appropriate sort of point cloud image processing operations including, for example, dropping out data points, replicating data points, changing background data points, rotating data points, scaling data points, adding noisy data points, translating data points, flipping data points, or a combination thereof. Each such transformation operation has one or more local hyperparameters that generally specify how the transformation operation should be applied to the point cloud included in each training input.

The system generates, from the original search space, a compact search space of the plurality of candidate data augmentation policies (step 406). The candidate data augmentation policies included in the compact search space can be much the same as the candidate data augmentation policies included in the original search space.

Unlike the original search space, however, the compact search space has one or more global hyperparameters, which are different from the local hyperparameters of the original search space. The number of global hyperparameters of the compact search space is significantly lower than the number of local hyperparameters of the original search space. Each global hyperparameter has a space of possible values, which can be either discrete or continuous.

For example, a candidate data augmentation policy, e.g., one that includes the “Frustum Drop” transformation operation mentioned above, in the original search space can have at least 5 local hyperparameters. In contrast, the compact search space can have only 2 global hyperparameters: the global magnitude hyperparameter m and a global probability hyperparameter p.

In particular, the system generates the compact search space by generating, for each candidate data augmentation policy in the plurality of candidate data augmentation policies, a definition of each of the one or more respective local hyperparameters of the candidate data augmentation policy in terms of one or more of the global hyperparameters. The definition can be a mathematical function that uses (i) one or more normalization coefficients, (ii) one or more normalization constants, or both (i) and (ii).

Step 406 is explained in more detail with reference to FIG. 5, which shows sub-steps 502-504 corresponding to step 406.

In general, the system can perform one iteration of the sub-steps 502-504 for each of the one or more respective local hyperparameters of each candidate data augmentation policy included in the original search space, to generate the definition of the local hyperparameters of the candidate data augmentation policy in terms of one or more of the global hyperparameters.

The system determines a value of a normalization coefficient, a value of a normalization constant, or both (step 502). The system can make this determination by first determining an optimal value of each of the one or more respective local hyperparameters of the candidate data augmentation policy, and then determining the value of the normalization coefficient, the value of the normalization constant, or both based on the optimal values of the respective local hyperparameters.

In some implementations, a grid search method is utilized to facilitate this determination. The grid search method refers to a method of exhaustive searching through a combination of every possible value of each of the one or more respective local hyperparameters to determine the optimal values for the respective local hyperparameters that result in the highest performance gain of a machine learning model after training.

More specifically, the system can select, for each of the one or more respective local hyperparameters, a value from the space of possible values for the respective local hyperparameter, and then train a proxy machine learning model for a predetermined number of training iterations on the training data set using the candidate data augmentation policy in accordance with the one or more respective local hyperparameters that have the selected values.

After having selected different values and subsequently trained multiple instances of the proxy machine learning models in this way, the system can then perform a grid search within a combination of every possible value of each of the one or more local hyperparameters to determine the optimal value for each of the one or more respective local hyperparameters based on the performance (e.g., prediction accuracy) attained by the proxy machine learning model as a result of the training. For example, the selected values of each of the one or more respective local hyperparameters that resulted in the highest prediction accuracy can be used as the optimal values.

In addition to the optimal values of the respective local hyperparameters, the determination of the value of the normalization coefficient, the value of the normalization constant, or both can also be based on the respective space of possible values of each of the one or more global hyperparameters. Specifically, the system can determine the value of the normalization coefficient, the value of the normalization constant, or both that will align the search domains across the plurality of candidate data augmentation policies included in the original search space.

For example, assuming that the space of possible values of the global probability hyperparameter p is is [0, 1], and that the space of possible values of the global magnitude hyperparameter m is [0, ∞], the system can determine the value of the normalization coefficient, the value of the normalization constant, or both for a given candidate data augmentation policy such that when the global hyperparameters have predetermined values, e.g., when (p, m)=(0.5, 5), the local hyperparameters for the given candidate data augmentation policy have their determined optimal values.

The system computes a mathematical function that uses (i) one or more normalization coefficients, (ii) one or more normalization constants, or both (i) and (ii) to define each of the one or more respective local hyperparameters of the candidate data augmentation policy in terms of one or more of the global hyperparameters (step 504). The system will generally compute different normalization coefficients, different normalization constants, or both during different iterations of the sub-steps 502-504.

For example, the system defines one local hyperparameter in terms of a global probability hyperparameter p by computing a function that has a single term representing a product between global probability hyperparameter p and a normalization coefficient. The normalization coefficient can have a first determined value.

As another example, the system defines another local hyperparameter in terms of a global probability hyperparameter p by computing a function that has (i) a first term representing a product between a global magnitude hyperparameter m and a normalization coefficient and (ii) a second term representing a normalization constant. The normalization coefficient can have a second determined value, and the normalization constant can have a third determined value.

The first, second, and third determined values in these two examples can be determined at step 502, e.g., as a result of the grid search method.

The system trains the machine learning model on the training data using one or more final data augmentation policies generated from the compact search space (step 408). Step 408 is explained in more detail with reference to FIG. 6, which shows sub-steps 602-606 corresponding to step 408.

In general, the system can repeatedly perform multiple iterations of sub-steps 602-606 to generate a trained machine learning model.

The system selects a batch of training data (step 602). The system will generally select different batches of training data at different iterations, e.g., by sampling a fixed number of training inputs from the training data set at each iteration with some degree of randomness.

The system generates an augmented batch of training data by transforming the training inputs in the batch of training data in accordance with the one or more final data augmentation policies (step 604).

Each final data augmentation policy can include one or more of the plurality of candidate data augmentation policies in the original search space. In implementations where each candidate data augmentation policy in the original search space is composed of a sequence of one or more transformation operations, a final data augmentation policy can similarly include a sequence of one or more transformation operations.

As mentioned above, each candidate data augmentation policy included in the original search space can have one or more respective local hyperparameters, which correspond to different aspects of the procedure defined by the candidate data augmentation policy. For example, the local hyperparameters specify how the transformation operation should be applied to a training input, e.g., the magnitude of the transformation operation, or the probability of applying the transformation operation.

In particular, the system generates each final data augmentation policy based on selecting, from the respective space of possible values, a respective final value of each of the one or more global hyperparameters. The system need not select the final values for any of the local hyperparameters of the candidate data augmentation policies included in the original search space. Instead, the respective final values of the one or more respective local hyperparameters of each candidate data augmentation policy included in the final data augmentation policy are, in turn, defined by the respective selected final values of the one or more global hyperparameters.

The system can select the respective final value of each of the one or more global hyperparameters in any of a variety of ways. For example, the system can do this by using random search techniques. As another example, the system can do this by using reinforcement learning techniques to maximize rewards that are derived from the quality measures of data augmentation policies generated at previous iterations. As yet another example, the system can do this by using evolutionary search techniques or population based training techniques that adjust the respective values of the one or more global hyperparameters over multiple iterations (“generations”) to improve the quality measures of data augmentation policies.

In these examples, for each data augmentation policy, the system can determine the quality measure of the data augmentation policy using the machine learning model after it has been trained using the data augmentation policy. For example, the system can determine the quality measure to be a performance measure (e.g., F1 score or mean squared error) of the trained machine learning model on a set of validation data composed of multiple training examples that were not used to train the machine learning model.

Continuing with the example where a final data augmentation policy includes the “Frustum Drop” transformation operation, the system need only determine a final value for the global magnitude hyperparameter m, and a final value for the global probability hyperparameter p. Because each of the five local hyperparameters has been defined in terms of the one or both of the two global hyperparameters, the final value for the local hyperparameter can be computed trivially in accordance with the definition, i.e., rather than searching through the space of possible values for the local hyperparameter. For example, as one of the five local hyperparameters of the “Frustum Drop” transformation operation, the final value of the R distance hyperparameter can be computed as 75−7.5 m.

In implementations where each final data augmentation policy includes a sequence of one or more transformation operations, to transform a training input using the final data augmentation policy, each transformation operation will be applied to the training input in accordance with the respective final values of the one or more global hyperparameters. For example, the system computes the final value of a local hyperparameter (the R distance hyperparameter) based on the final value of the global magnitude hyperparameter m, and applies the “Frustum Drop” transformation operation in accordance with the computed final value of the local hyperparameter (the R distance hyperparameter).

The system trains the machine learning model to adjust parameters values of the machine learning model based on the augmented batch of training data (step 606). In some implementations, the system can generate the one or more final data augmentation policies by performing a search phase within the compact search space before training the machine learning model. That is, during the search phase, the system searches through the compact search space to find optimal values of the global hyperparameters that define the one or more final data augmentation policies. Then, during the training phase, the system holds the optimal values of the global hyperparameters fixed, and only adjusts parameters values of the machine learning model.

In some other implementations, the system can generate the one or more final data augmentation policies for training the machine learning model without executing a search phase before the training. Rather, the system can determine optimal values of the global hyperparameters in parallel with determining other hyperparameters, parameters, or both of the machine learning model itself. Thus, the optimal values of the global hyperparameters, the hyperparameters, parameters, or both of the machine learning model will be jointly adjusted.

More specifically, the system processes the transformed training inputs in accordance with the current parameter values of the machine learning model to generate corresponding outputs. The system then determines gradients of an objective function that measures a similarity between: (i) the outputs generated by the machine learning model, and (ii) the target outputs specified by the transformed training examples, and uses the gradients to adjust the current values of the machine learning model parameters. The system can determine the gradients using, e.g., a backpropagation procedure, and the system can use the gradients to adjust the current values of the machine learning model parameters using any appropriate gradient descent optimization procedure, e.g., an RMSprop or Adam procedure.

The system can repeatedly perform the steps 602-606 until a training termination criterion is satisfied (e.g., if the steps 602-606 have been performed a predetermined number of times or if the gradients of the objective function have converged to a predetermined value).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining data defining an original search space of a plurality of candidate data augmentation policies, wherein each candidate data augmentation policy defines a procedure for processing a training input comprising three-dimensional point cloud data to generate a transformed training input, and wherein each candidate data augmentation policy has one or more respective local hyperparameters corresponding to different aspects of the procedure defined by the candidate data augmentation policy;
generating, from the original search space, a compact search space that has one or more global hyperparameters; and
training the machine learning model using one or more final data augmentation policies generated from the compact search space to perform a three-dimensional perception task.

2. The method of claim 1, wherein each local hyperparameter or global hyperparameter has a respective space of possible values.

3. The method of claim 1, wherein generating the compact search space that has one or more global hyperparameters comprises, for each candidate data augmentation policy in the plurality of candidate data augmentation policies:
defining each of the one or more respective local hyperparameters of the candidate data augmentation policy in terms of one or more of the global hyperparameters by using one or more normalization coefficients, one or more normalization constants, or both.

4. The method of claim 3, wherein defining each of the one or more respective local hyperparameters of the candidate data augmentation policy in terms of one or more of the global hyperparameters comprises, for each of the one or more respective local hyperparameters:
determining a value of a normalization coefficient, a value of a normalization constant, or both; and
computing a function that has a first term representing a product between a global hyperparameter and the normalization coefficient having the determined value, a second term representing the normalization constant having the determined value, or both the first term and the second term.

5. The method of claim 4, wherein determining the value of the normalization coefficient, the value of the normalization constant, or both comprises:
determining, for each respective local hyperparameter of the candidate data augmentation policy, the value of the normalization coefficient, the value of the normalization constant, or both that are different from the value of the normalization coefficient, the value of the normalization constant, or both of another respective local hyperparameter of the candidate data augmentation policy.

6. The method of claim 4, wherein determining the value of the normalization coefficient, the value of the normalization constant, or both comprises:
determining an optimal value of each of the one or more respective local hyperparameters of the candidate data augmentation policy;
determining the value of the normalization coefficient, the value of the normalization constant, or both based on the optimal values of the respective local hyperparameters and the respective space of possible values of each of the one or more global hyperparameters.

7. The method of claim 6, wherein determining the optimal value of each of the one or more respective local hyperparameters of the candidate data augmentation policy comprises, for each candidate data augmentation policy in the plurality of candidate data augmentation policies:
selecting a value from the respective space of possible values of each of the one or more respective local hyperparameters; and
training a proxy machine learning model for a predetermined number of training iterations using the candidate data augmentation policy in accordance with the one or more respective local hyperparameters that have the selected values.

8. The method of claim 6, wherein determining the optimal value of each of the one or more respective local hyperparameters of the candidate data augmentation policy comprises:
performing a grid search within a combination of every possible value of each of the one or more local hyperparameters to determine the optimal value based on a performance attained by the proxy machine learning model as a result of the training.

9. The method of claim 1, wherein the three-dimensional perception task comprises a three-dimensional object detection task.

10. The method of claim 9, wherein obtaining data defining the original search space of the plurality of candidate data augmentation policies comprises:
obtaining data defining a point cloud augmentation policy which defines a procedure of modifying a point cloud generated by using a LIDAR sensor in a training input while accounting for occlusion from a point of view of the LIDAR sensor.

11. The method of claim 9, wherein the procedure for processing the training input defined by each candidate data augmentation policy comprise one of: dropping out data points, replicating data points, changing background data points, rotating data points, scaling data points, adding noisy data points, translating data points, or flipping data points within the training input.

12. The method of claim 11, wherein for the candidate data augmentation policy that defines the procedure of dropping out data points, the candidate data augmentation policy has a first local hyperparameter corresponding to a probability of applying the procedure to the training input and a second local hyperparameter corresponding to a ratio of dropped out data points to all data points in the training input.

13. The method of claim 12, wherein defining the first local hyperparameter of the candidate data augmentation policy in terms of one or more of the global hyperparameters comprises:
computing a function that has a single term representing a product between a first global hyperparameter and a normalization coefficient having a first determined value.

14. The method of claim 12, wherein defining the second local hyperparameter of the candidate data augmentation policy in terms of one or more of the global hyperparameters comprises:
computing a function that has (i) a first term representing a product between a second global hyperparameter and a normalization coefficient having a second determined value and (ii) a second term representing a normalization constant having a third determined value.

15. The method of claim 9, wherein the machine learning model is a neural network comprising one or more multi-layer perceptions, a fully convolutional backbone, a heatmap prediction head, and a bounding box regression head.

16. The method of claim 1, wherein training the machine learning model using the one or more final data augmentation policies generated from the compact search space comprises:
generating each final data augmentation policy based on selecting a respective final value from the respective space of possible values of each of the one or more global hyperparameters, each final data augmentation policy comprising some or all of the plurality of candidate data augmentation policies in the original search space, each candidate data augmentation policy included in the final data augmentation policy having respective final values of the one or more respective local hyperparameters that are defined by the respective final values of the one or more global hyperparameters.

17. The method of claim 1, wherein training the machine learning model using the one or more final data augmentation policies generated from the compact search space comprises:
selecting a batch of training data from a training data set;
generating an augmented batch of training data by transforming the training inputs in the batch of training data in accordance with the one or more final data augmentation policies; and
adjusting parameters values of the machine learning model based on the augmented batch of training data.

18. A system comprising one or more computers and one or more storage devices storing instructions that are operable, when executed by the one or more computers, to cause the one or more computers to perform operations comprising:
obtaining data defining an original search space of a plurality of candidate data augmentation policies, wherein each candidate data augmentation policy defines a procedure for processing a training input comprising three-dimensional point cloud data to generate a transformed training input, and wherein each candidate data augmentation policy has one or more respective local hyperparameters corresponding to different aspects of the procedure defined by the candidate data augmentation policy;
generating, from the original search space, a compact search space that has one or more global hyperparameters; and
training the machine learning model using one or more final data augmentation policies generated from the compact search space to perform a three-dimensional perception task.

19. The system of claim 18, wherein training the machine learning model on the training data using the one or more final data augmentation policies generated from the compact search space comprises:
selecting a batch of training data from a training data set;
determining an augmented batch of training data by transforming the training inputs in the batch of training data in accordance with the one or more final data augmentation policies; and
adjusting parameters values of the machine learning model based on the augmented batch of training data.

20. A non-transitory computer storage medium encoded with instructions that, when executed by one or more computers, cause the one or more computers to perform operation comprising:
obtaining data defining an original search space of a plurality of candidate data augmentation policies, wherein each candidate data augmentation policy defines a procedure for processing a training input comprising three-dimensional point cloud data to generate a transformed training input, and wherein each candidate data augmentation policy has one or more respective local hyperparameters corresponding to different aspects of the procedure defined by the candidate data augmentation policy;
generating, from the original search space, a compact search space that has one or more global hyperparameters; and
training the machine learning model using one or more final data augmentation policies generated from the compact search space to perform a three-dimensional perception task.
